(19) United States
(12) Patent Application Publication
(10) Pub. No.: US 2004/0053593 A1
(43) Pub. Date: Mar. 18, 2004

(54) Signal mixers

(76) Inventor: William Mark Siddall, Christchurch (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/416,390

(22) PCT Filed: Nov. 9, 2001
(86) PCT No.: PCT/NZ01/00251

(30) Foreign Application Priority Data
Nov. 9, 2000 (NZ) 508054

(51) Int. Cl. H04B 1/10

(52) U.S. Cl. 455/307

(57) ABSTRACT

The invention relates to a double balanced diode mixer (10) in which an input transformer (20) is replaced by an equivalent circuit (50) which approximates the functionality of the input transformer (20). The circuit includes an LCR network (50) which filters an input RF message signal and further includes a portion which approximates a functionality of transformer to provide RF differential output signals (61, 62) for transfer to a diode ring (21).

### FIELD OF THE INVENTION

This invention relates to circuits for mixing radio signals and in particular to double balanced diode mixers for generating an IF output signal from an RF input signal. It will be appreciated however that the invention is not limited to use with only double balanced diode mixers. The invention may also be implemented for single balanced mixers, doubly doubly balanced mixers and harmonic mixers, for example.

### BACKGROUND TO THE INVENTION

Double balanced diode mixers (DBDM) are widely used in telecommunications equipment for converting an input message signal with a particular carrier frequency to an output message signal with a different carrier frequency. DBDMs can also be used as modulators and demodulators.

A typical DBDM circuit comprises an input transformer or balun for receiving an input signal, for example a radio frequency (RF) message signal. The transformer has a differential output for providing two opposite phase output signals, which are fed into two nodes of a diode ring. Two remaining nodes of the diode ring are connected to a differential input of a second or output transformer, which includes a centre tap for a local oscillator (LO) signal on a primary winding, and a single ended output on a secondary winding which contains a mixed output signal.

The diode ring mixes the LO signal with the RF message signal to produce a signal which includes various components including two intermediate frequency (IF) message signals. The output IF message signals have carrier frequencies of ±F_{IF}=±F_{LO}±F_{RF} respectively. A DBDM arrangement will typically have an input filter circuit on the front-end for conditioning the RF input message signal, and also an output filter circuit or diplexer on the back-end for removing undesired components of the mixed signal and to terminate the RF signal in a load. The diplexer can be tuned to one of the IF carrier frequencies to pass the desired IF signal to the output.

The diode ring mixer, input filter and diplexer of a DBDM mixer can be constructed in a compact manner using surface mount and/or integrated circuit technology. However the input and output transformers are by nature bulky devices which increase the overall size of a DBDM mixer.

### SUMMARY OF THE INVENTION

It is an object of the present invention to remove the need for an input transformer of a DBDM by implementing an equivalent circuit which approximates the functionality of the input transformer, or at least to provide an alternative to existing DBDM systems. In general terms the invention provides a circuit, which combines the functionality of the input filter with that of the input transformer. In one embodiment of the invention the circuit provides a LCR network which filters an input RF message signal as required, and further includes a portion which approximates the functionality of a transformer to provide RF differential output signals and to add an externally generated LO component to each differential output signal. In an alternative embodiment the circuit could be implemented using a microstrip arrangement.

In one aspect the invention may be said to consist in a method of generating output signals for transfer to a diode ring in a mixing circuit including: filtering a first input signal, phase splitting the first input signal to produce a differential signal, and combining each differential signal with a second input signal, to produce output signals for transfer to the diode ring.

In another aspect the invention may be said to consist in an input stage for a mixing circuit, including a LCR network having a filter for providing signal conditioning of a first input signal, a phase splitter for producing a differential output signal from the input signal, and additive functionality for combining each differential output signal with a second input signal.

In another aspect the invention may be said to consist in a LCR network for generating a differential signal for input to a diode ring including: a filter portion for conditioning a first input signal, and a portion implementing an approximation model of a transformer for producing a differential output signal and injecting a second signal into each differential output.

In another aspect the invention may be said to consist in a circuit for mixing electromagnetic signals including: a filter for signal conditioning of an input signal, a sub circuit for phase splitting the filtered input signal into differential output signals and adding a second input signal to each differential output signal, and a diode ring for switching each differential signal and added second signal, wherein the sub circuit approximates the functionality of a differential output transformer with a centre tap.

The invention may also be said to consist in any alternative combination of parts or features as described or shown in the accompanying drawings. Known equivalents of these parts or features not expressly set out are nevertheless deemed to be included.

### BRIEF DESCRIPTION OF THE DRAWINGS

Preferred embodiments of the invention will now be described with reference to the accompanying figures, of which:

FIG. 1 is a receiver block diagram showing an input filter, DBDM and diplexer of a typical implementation of a DBDM for frequency conversion,

FIG. 2 shows in further detail the DBDM stage of the mixing circuit,

FIG. 3 shows a circuit diagram of the DBDM stage,

FIG. 4 shows a circuit diagram of the input filter stage,

FIG. 5 shows a block diagram of a modified input stage which implements the combined functionality of a front-end filter and differential output transformer,

FIG. 6 shows a circuit diagram of a preferred embodiment of the modified input stage, and

FIG. 7 shows a circuit diagram of an alternative equivalent circuit for replacing the differential output transformer.

### DETAILED DESCRIPTION OF THE PREFERRED EMBODIMENTS

Referring to the drawings it will be appreciated that the input circuit according to the invention can be implemented in various forms. The following examples are given by way of example only. It will also be appreciated that details relating to filter design and component selection will be understood by those skilled in the art and need not be described in detail here. It should also be appreciated that, although illustrated and described as a down conversion mixer, the DBDM is well known to those skilled in the art as a bi-directional mixer and can be equally used as an up-conversion mixer, modulator or demodulator. The input circuit can be used in conjunction with the output circuit from the mixing circuit which is disclosed in NZ application no. 508053.

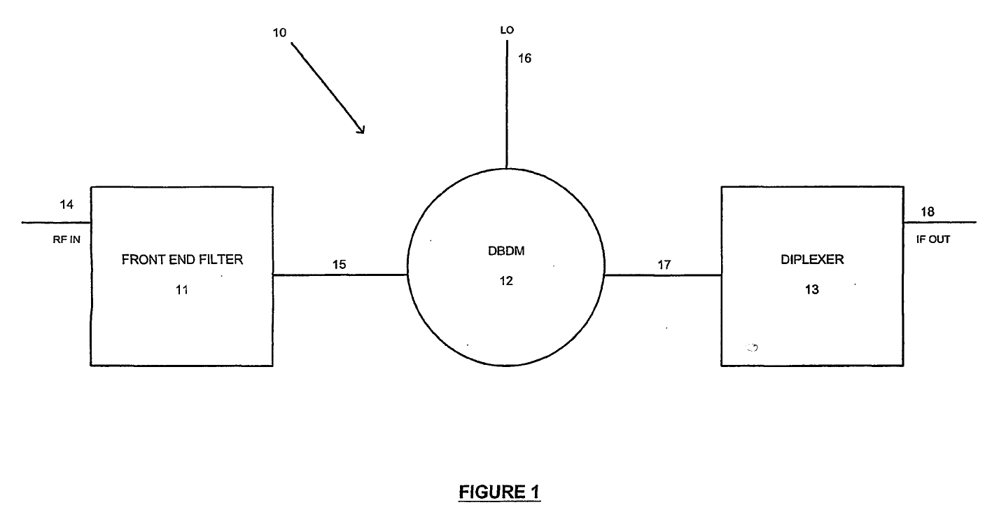

FIG. 1 shows the general structure of an existing mixing circuit 10 which implements a DBDM 12. The operation of such a circuit will be known to those skilled in the art although will be briefly explained for reasons of clarity in the description overall. The circuit includes a front-end filter 11 which has a single ended input for receiving, for example, a RF input message signal 14. The filter 11 performs signal conditioning on the input signal 14 to remove undesirable noise and unwanted signals. The filtered signal 15 is then passed to the DBDM 12 where an externally generated LO signal 16 is mixed with the filtered signal 15 to produce a mixed signal 17 which contains various components as a result of the mixing operation. The mixed signal is passed to a diplexer 13 where undesired components, including the original RF message signal 15 and LO signal 16 are terminated in a load to provide a single ended IF output message signal 18 which can be used as required by the remaining portion of telecommunications equipment in which the mixer is being implemented.

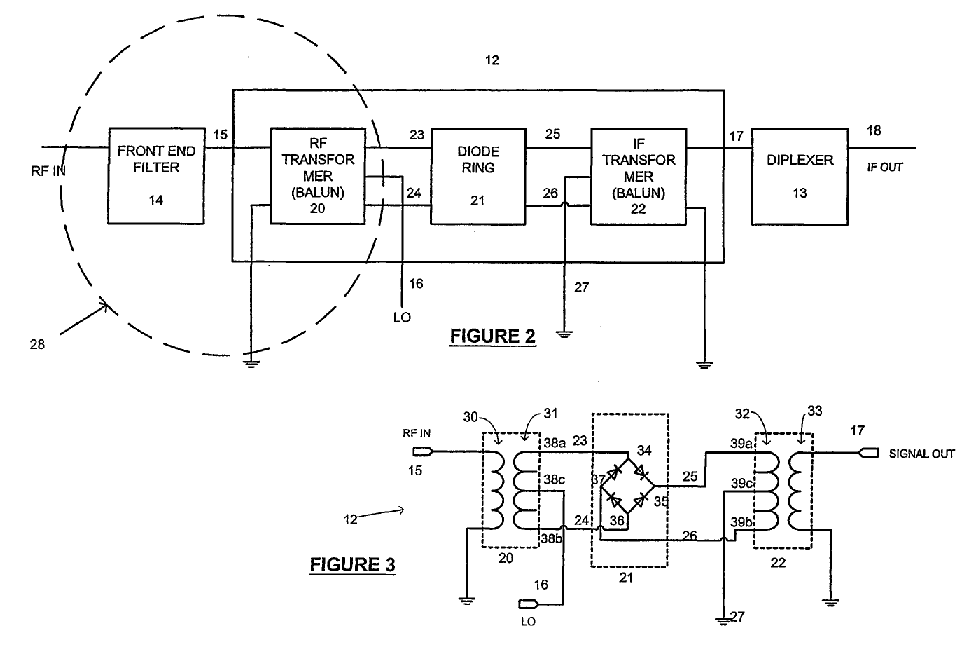

FIG. 2 shows the DBDM 12 in further detail. The filtered signal 15 is passed into one input terminal of a transformer 20 of which the other input terminal is grounded. The transformer 20 generates a differential output 23, 24 on a secondary winding, one output comprising the filtered signal 15 and another comprising the same signal but phase shifted by 180°. The LO 16 signal is fed into an input centre tap of the transformer 20. Each output 23, 24 is coupled to an opposing node of a diode ring 21. Two other opposing nodes of the diode ring are connected to differential input terminals 25, 26 of an output transformer 22. A centre tap 27 of the primary winding of the output transformer 22 is connected to earth. A single ended output terminal of the transformer 22 is coupled to the diplexer, while the other output terminal is grounded. It should be noted that somebody skilled in this area of technology would appreciate that the input and output transformers could be replaced by baluns.

FIG. 3 shows a circuit diagram of the DBDM 12 shown in FIG. 2. The input transformer 20 includes a single ended primary winding 30 with a centred tapped differential secondary winding 31. Similarly the output transformer 22 includes a centred tapped differential input primary winding 32 and a single ended secondary winding 33. The diode ring consists of four diodes arranged such that only two of the diodes conduct at any one time depending on the polarity of the LO signals at the nodes 34, 36. The filtered input signal 15 is fed into one terminal of a primary winding 30 of the input transformer 20. The differential output terminals 38a, 38b of the secondary winding 31 are coupled to opposite nodes 34, 36 of the diode ring while the two other opposing nodes 35, 37 are coupled to the differential inputs terminals 39a, 39b of the primary winding 32 of the output transformer 22.

The LO signal 16 is fed into the centre tap 38c of the input transformer 20 secondary winding 31 and in turn fed into the diode ring 21 to input nodes 34, 36 via the differential output terminals 38a, 38b. The single ended output signal 17 is generated on an output terminal of the output transformer's 22 secondary winding 33, while the other output terminal is earthed. During operation of the mixer 12 the LO signal 16 is fed into the diode ring and alternately switches opposing diode pairs on and off which alternates the differential RF output signal 23, 24 between the differential input terminals 39a, 39b of the output transformer 22. It will be appreciated by those skilled in the art that in an alternative embodiment the LO 16 could readily be injected into a centre tap 39c of the primary winding 32 of the output transformer 22 with the centre tap 38c of the primary winding 31 of the input transformer 20 being connected to ground. Either configuration of LO 16 and ground connections to the centre taps 38c,39c can be used as required. One configuration may be preferable to the other in certain implementations.

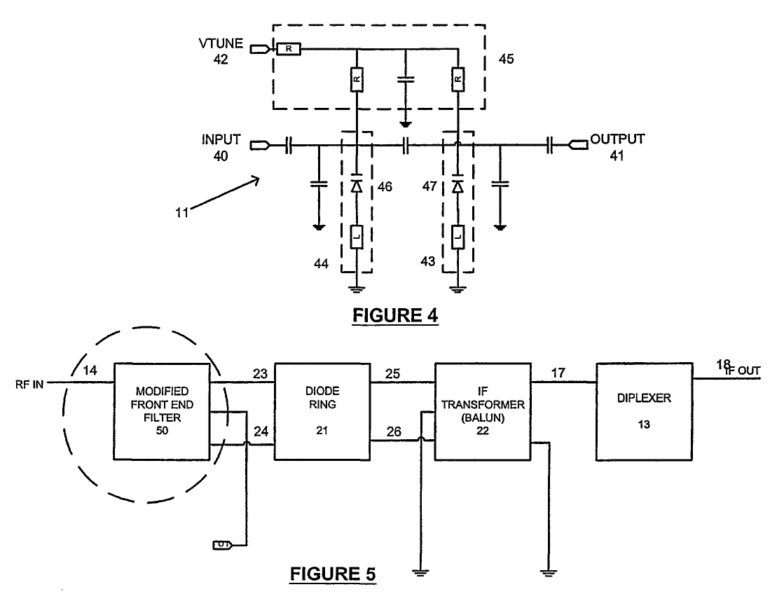

FIG. 4 is a circuit diagram of a front-end input filter 11 for the mixing circuit 12. The circuit includes a terminal 40 for the RF input message signal 14 and an output terminal 41 for the filtered signal 15. The circuit further includes a tuning terminal 42 and varicap tuned diodes 46, 47 to facilitate adjustment of the circuit for operation at desired frequencies. In this manner the two LC arrangements 43, 44 can be customised in conjunction with the resistor network 45 to effect a low impedance path to ground for undesired frequency components of the input signal 14. In particular the arrangement can be adjusted to remove unwanted noise, distortion and other components of specific frequencies from the RF input signal 14.

FIG. 5 shows a block diagram of a preferred embodiment of the invention including a modified front-end filter 50 which is implemented to approximate the combined functionality of the front-end filter 11 and input transformer 20 as encircled 28 in FIG. 2. Effectively the circuit is an LCR model, or equivalent circuit, of the front-end filter 11 and transformer 20. Alternatively the equivalent circuit could be implemented using microstrip technology. The modified filter SO generates a differential output 23, 24 which can be fed into a diode ring to enable the modified filter 50 to be directly substituted for the front-end filter 11 and input transformer 20 which are typically used in a mixing circuit 10.

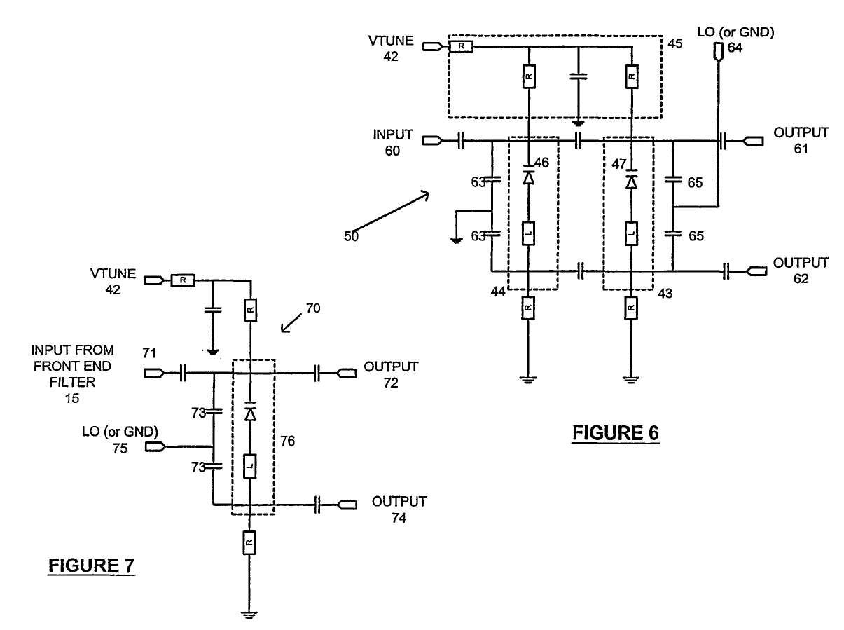

FIG. 6 is a circuit diagram of a preferred embodiment of the modified filter 50. A single ended input terminal 60 is provided in an LCR network which contains the adjustment terminal 42, resistor network 45 and two LC arrangements 43, 44 of the original front-end filter 11. Unwanted signal components of an input signal present on the input terminal 60 are removed by the LC networks 43, 44 in conjunction with capacitors 63, 65 in the manner as explained with reference to FIG. 4. The filtered signal is then passed to a first differential output terminal 61. Due to the fact that LC network 44 is resonant with capacitors 63 and LC network 43 is resonant with capacitors 65 the signal passed to the output 62 is phase shifted by 180° relative to the signal on output terminal 61. An LO signal is injected into each differential output signal by way of a second input terminal 64 and two series capacitors 65. The relative phase of the LO components in each output signal is 0°. Each output signal therefore includes a RF message signal added to a LO signal with the RF message signal in each output having a relative phase shift of 180°. As noted above it will be appreciated that in an alternative embodiment the LO input terminal 64 could be the ground terminal, and the LO signal could be injected to the centre tap 39c of the transformer 22.

FIG. 7 shows an alternative embodiment of the invention in which the functionality of the front-end filter 11 and input transformer 20 is not combined in a single circuit. Rather the original front-end filter 11 is retained and the transformer 20 is replaced by a LCR equivalent circuit 70 of the transformer 20. The filtered signal 15 from the front end filter 11 is fed into an input terminal 71 of the equivalent circuit 70. The filtered input signal 15 undergoes further filtering using a LC network and the resulting signal is fed to one differential output terminal 72. The resulting signal is also fed through a series capacitor network 73 and LC circuit 76 which phase shifts the signal by 180° for subsequent transmission to a second differential output terminal 74. An LO signal is injected via terminal 75 into each differential output signal by way of a second input terminal 75 and the two series capacitors 73 which keep a relative phase shift of 0° between the LO components in each output signal. The differential output terminals 72, 74 can be coupled to opposing nodes of a diode ring to feed the combined LO and RF signals to the ring for mixing. Bach output signal therefore includes a RF message signal added to a LO signal, with the RF message signal in each output having a relative phase shift of 180°. The equivalent circuit further includes an input terminal 42 and associated circuitry for adjusting the frequency response of the circuit as required. Again it will be appreciated that in an alternative embodiment the LO terminal 75 could be the ground terminal instead with the LO fed to the centre tap 39c of the transformer 22.

1. A method of generating output signals for transfer to a diode ring in a mixing circuit including:
filtering a first input signal,
phase splitting the first input signal to produce a differential signal, and
combining each differential signal with a second input signal, to produce output signals for transfer to the diode ring.

2. A method according to claim 1 wherein the filtered first input signal is fed into an inductive and capacitive network implementing an equivalent circuit of a transformer which phase splits the input signal and combines each differential signal with the second input signal.

3. A method according to claim 2 wherein the first input signal is filtered by a portion of an LCR network.

4. A method according to claim 3 wherein the first input signal is a RF signal and the second input signal is a local oscillator signal.

5. A method according to claim 4 further including tuning the LCR circuit by way of an adjustment input.

6. An input stage for a mixing circuit, including a LCR network having a filter for providing signal conditioning of a first input signal, a phase splitter for producing a differential output signal from the input signal, and additive functionality for combining each differential output signal with a second input signal.

7. An input stage according to claim 6 wherein the phase splitter and additive functionality are implemented using a portion of the LCR network which approximates a differential output transformer with a centre tap.

8. An input stage according to claim 7 wherein the first input signal is a RF signal and the second input signal is a local oscillator signal.

9. An input stage according to claim 8 further including an adjustment control for tuning the LCR network.

10. A LCR network for generating a differential signal for input to a diode ring including:
a filter portion for conditioning a first input signal, and
a portion implementing an approximation model of a transformer for producing a differential output signal and injecting a second signal into each differential output.

11. A circuit for mixing electromagnetic signals including:
a filter for signal conditioning of an input signal,
a sub circuit for phase splitting the filtered input signal into differential output signals and adding a second input signal to each differential output signal, and
a diode ring for switching each differential signal and added second signal,
wherein the sub circuit approximates the functionality of a differential output transformer with a centre tap.

12. A method of generating output signals for transfer to a diode ring in a mixing circuit substantially as hereinbefore described with reference to the accompanying drawings.

13. An input stage for a mixing circuit substantially as hereinbefore described with reference to the accompanying drawings.

14. A LCR network for generating a differential signal for input to a diode ring substantially as hereinbefore described with reference to the accompanying drawings.

15. A circuit for mixing electromagnetic signals substantially as hereinbefore described with reference to the accompanying drawings.
